(19) United States
(12) Patent Application Publication
(10) Pub. No.: US 2010/0324814 A1
(43) Pub. Date: Dec. 23, 2010

(54) GPS TRACKING SYSTEM

(75) Inventors: BING-FEI WU, Hsinchu (TW); Ying-Han Chen, Hsinchu (TW); Chao-Jung Chen, Hsinchu (TW); Chih-Chung Kao, Hsinchu (TW); Po-Chia Huang, Hsinchu (TW)

Correspondence Address: WPAT, PC;INTELLECTUAL PROPERTY ATTORNEYS, 7225 BEVERLY ST., ANNANDALE, VA, 22003, US

(73) Assignee: National Chiao Tung University, Hsinchu (TW)

(21) Appl. No.: 12/761,471

(22) Filed: Apr. 16, 2010

(30) Foreign Application Priority Data
Jun. 23, 2009 (TW) 098120995

(51) Int. Cl. G01C 21/00; G01S 19/42; G06F 15/16

(52) U.S. Cl. 701/208; 701/213; 709/219

(57) ABSTRACT

The present invention relates a GPS tracking system, comprising a tracking and positioning device, a server, a positioning display unit, and a database. Since the tracking and positioning device only sends an Internet protocol (IP) data and a verification data once when it is connected to the Internet, and sends a positioning data only when a position of the tracking and positioning device is to be shown on the positioning display unit, the bandwidth can be saved.

### 1. TECHNICAL FIELD

The present invention generally relates to a GPS tracking system and, more particularly, to a GPS tracking system having a tracking and positioning device that only sends an Internet protocol (IP) data and a verification data once when it is connected to the Internet, and sends a positioning data only when a position of the tracking and positioning device is to be shown on the positioning display unit.

### 2. TECHNICAL BACKGROUND

Concerning data exchange applications, the conventional mobile device is generally a slave device that uploads data to a remote server or downloads data from a remote server. Such a mobile device is suitable for use in applications where the mobile device is used as a master device because the data uploaded or downloaded by the mobile devices is necessary. Moreover, the connection fee can be self-determined.

However, if the mobile device is used as an information provider, a third-party server with the public IP is required as a relay to upload information from the mobile device to a user requesting the information because the user cannot be directly connected to the mobile device with the private IP, as shown in FIG. 1.

In order for the user to acquire the real-time information at the mobile device end on the positioning display unit, the mobile devices (such as a tracking and positioning device) is required to continuously provide the third-party server with information, which leads to a heavy load at the mobile device end. Firstly, a great portion of the bandwidth is occupied due to continuously providing information. Secondly, the connection fee amounts to an extra cost.

As a matter of fact, the connection fee is not the most important issue. If the user has to be on-line anyway, the connection fee is sure to be paid. Some unnecessary or useless information may be provided, which means that the bandwidth and cost are wasted in vain.

Therefore, there is need in providing a GPS tracking system having a tracking and positioning device that only sends an Internet protocol (IP) data and a verification data once when it is connected to the Internet, and sends a positioning data only when a position of the tracking and positioning device is to be shown on the positioning display unit.

### SUMMARY

It is one object of the present invention to save bandwidth and cost by providing a GPS tracking system having a tracking and positioning device that only sends an Internet protocol (IP) data and a verification data once when it is connected to the Internet, and sends a positioning data only when a position of the tracking and positioning device is to be shown on the positioning display unit.

In one embodiment, the present invention provides a GPS tracking system, comprising: a tracking and positioning device, capable of sending an Internet protocol data and a verification data; and a server, capable of receiving and storing the Internet protocol data and the verification data; wherein the tracking and positioning device only sends the Internet protocol data and the verification data once when the tracking and positioning device is connected to the Internet, the server inquires and reads the Internet protocol data from a database when a positioning display unit requests a positioning data from the server, and the server is connected to the tracking and positioning device and requests the positioning data from the tracking and positioning device and sends the positioning data to the positioning display unit to show a position of the tracking and positioning device.

### BRIEF DESCRIPTION OF THE DRAWINGS

The embodiment of the present invention will be readily understood by the accompanying drawings and detailed descriptions, wherein:

FIG. 1 is a diagram showing conventional data transmission;

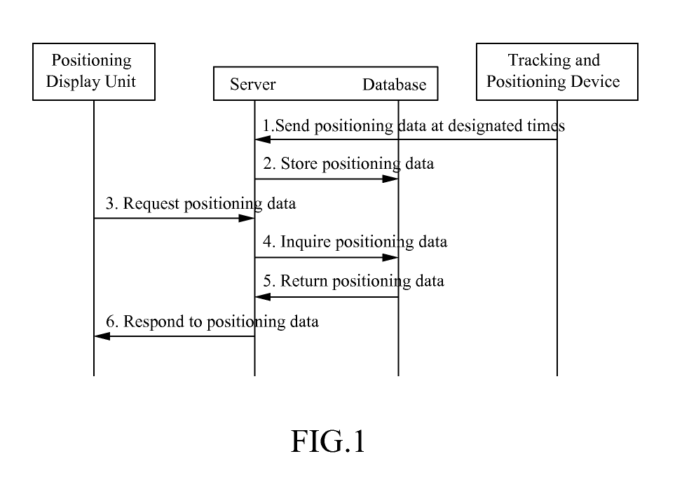

FIG. 2 is a block diagram of a GPS tracking system according to one embodiment of the present invention; and

FIG. 3 is a diagram showing data transmission according to one embodiment of the present invention.

### DETAILED DESCRIPTION OF EMBODIMENTS

The present invention can be exemplified but not limited by the embodiment as described hereinafter.

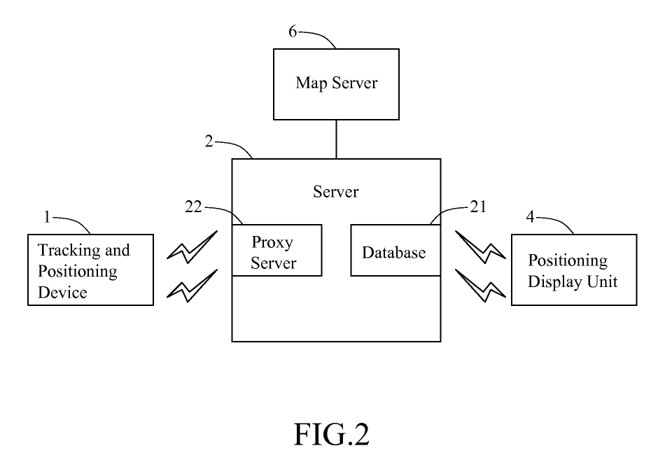

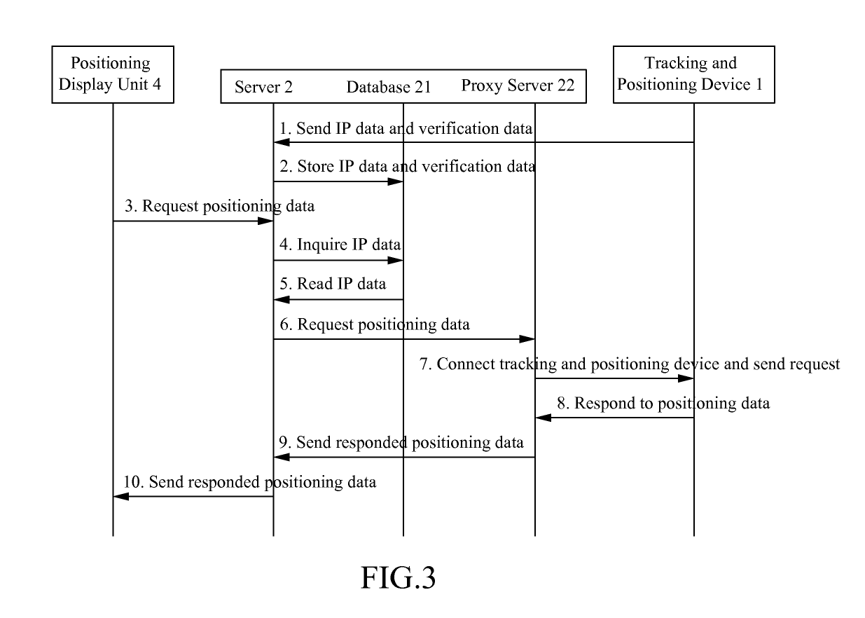

FIG. 2 and FIG. 3 show a block diagram of a GPS tracking system and a diagram showing data transmission by the GPS tracking system according to one embodiment of the present invention. Referring to FIG. 2 and FIG. 3, the present invention provides a GPS tracking system, comprising: a tracking and positioning device 1, capable of sending an Internet protocol (IP) data and a verification data; and a server 2, capable of receiving and storing the Internet protocol (IP) data and the verification data. Preferably, the tracking and positioning device 1 sends the Internet protocol data and the verification data to the server 2 via a mobile web. The tracking and positioning device 1 only sends the Internet protocol data and the verification data to the server 2 once when the tracking and positioning device 1 is connected to the Internet. Then, the server 2 inquires and reads the Internet protocol data from a database 21 when a positioning display unit 4 requests a positioning data from the server 2. Then, the server 2 is connected to the tracking and positioning device 1 and requests the positioning data from the tracking and positioning device 1 and sends the positioning data to the positioning display unit 4 to show a position of the tracking and positioning device 1.

In one embodiment, the positioning display unit 1 requests the positioning data from the server 2 via the Internet. To save the space for hardware implementation, the server 2 and the database 21 are preferably installed inside a computer. Generally, when the server 2 cannot be directly connected to the tracking and positioning device 1 due to cross-domain security issues, a proxy server 22 is required. Accordingly, the server 2 is connected to the tracking and positioning device 1 via the proxy server 22 and requests the positioning data from the tracking and positioning device 1 via the proxy server 22. Similarly, the proxy server 22 can be installed inside a computer with the server 2 and the database 21. Since the acquired positioning data may be in a format of coordinate-based data, the GPS tracking system of the present invention preferably comprises a map server 6 to provide the server 2 with a map so that the position of the tracking and positioning device 1 can be more readily identified by the user. As the positioning data and the map are provided, the position of the tracking and positioning device 1 can be clearly known.

It is thus obviously understood that the present invention provides a GPS tracking system having advantages over the priorart GPS tracking system as summarized herein:

| | Prior art | The present invention |
|---|---|---|
| Connection | Sending positioning | Sending positioning |
| | information at | information if |
| | designated times | necessary |
| Real-time | Based on frequency | Based on bandwidth |
| information | | |
| Information | Passive | Active |
| transmission | | |
| Bandwidth | Many | Few |
| requirements | | |
| ConnectionFee | Many | Few |

Accordingly, the present invention saves bandwidth and cost by providing a GPS tracking system having a tracking and positioning device that only sends an Internet protocol (IP) data and a verification data once when it is connected to the Internet, and sends a positioning data only when a position of the tracking and positioning device is to be shown on the positioning display unit. Therefore, the present invention is useful, novel and non-obvious.

Although the present invention has been disclosed and illustrated with reference accelerometer to particular embodiments, the principles involved are susceptible for use in numerous other embodiments that will be apparent to persons skilled in the art. The present invention is, therefore, to be limited only as indicated by the scope of the appended claims.

What is claimed is:

1. A GPS tracking system, comprising:
a tracking and positioning device, capable of sending an Internet protocol data and a verification data; and
a server, capable of receiving and storing the Internet protocol data and the verification data;
wherein the tracking and positioning device only sends the Internet protocol data and the verification data once when the tracking and positioning device is connected to the Internet, the server inquires and reads the Internet protocol data from a database when a positioning display unit requests a positioning data from the server, and the server is connected to the tracking and positioning device and requests the positioning data from the tracking and positioning device and sends the positioning data to the positioning display unit to show a position of the tracking and positioning device.

2. The GPS tracking system as recited in claim 1, further comprising a proxy server so that the server is connected to the tracking and positioning device via the proxy server and requests the positioning data from the tracking and positioning device via the proxy server.

3. The GPS tracking system as recited in claim 1, wherein the server and the database are installed inside a computer.

4. The GPS tracking system as recited in claim 2, wherein the server, the database and the proxy server are installed inside a computer.

5. The GPS tracking system as recited in claim 1, wherein the positioning display unit requests the positioning data from the server via the Internet.

6. The GPS tracking system as recited in claim 1, further comprising a map server capable of providing the server with a requested map.

7. The GPS tracking system as recited in claim 1, wherein the tracking and positioning device sends the Internet protocol data and the verification data to the server via a mobile web.
